(19) United States
(12) Patent Application Publication
(10) Pub. No.: US 2026/0124649 A1
(43) Pub. Date: May 7, 2026

(54) Dust Collecting Device

(71) Applicant: METAL INDUSTRIES RESEARCH & DEVELOPMENT CENTRE, Kaohsiung City (TW)

(72) Inventors: CHI-AN CHEN, Taipei City (TW); Yue-Jun Wang, New Taipei City (TW); Shu-Feng Lee, Tainan City (TW); Chin-Jou Chang, Taoyuan City (TW); Li-Wen Weng, Kaohsiung City (TW); Hsin-Fei Wang, Pingtung County (TW); Chun-Chieh Tseng, Kaohsiung City (TW)

(21) Appl. No.: 18/935,696

(22) Filed: Nov. 4, 2024

(51) Int. Cl. B08B 15/02; A47L 7/00; C23C 4/134

(52) U.S. Cl. CPC B08B 15/02; A47L 7/0047; C23C 4/134

(57) ABSTRACT

A dust collecting device includes a frame having a plurality of shielding sides surrounding a working space and an open side. A plurality of impact-resistant plates made of heat-resistant and anti-stick material is detachably disposed on at least one of the plurality of shielding sides facing the open side. A receiving plate is disposed on a bottom portion of the frame and includes at least one slope and a pipe intercommunicating with a storage box. The at least one slope is inclined toward the pipe and includes a bottom end contiguous to an upper opening of the pipe. An angle between a bottom edge of the at least one slope and an edge of the upper opening of the pipe is greater than 90 degrees. A vibration module drives the receiving plate to vibrate to move dusts on the at least one slope into the storage box through the pipe.

### BACKGROUND OF THE INVENTION

### 1. Field of the Invention

The present invention relates to a technique for recovering processing materials and, more particularly, to a dust collecting device for avoiding splash and sticking of dust during processing to thereby increase the recovery rate of materials.

### 2. Description of the Related Art

A conventional thermal spraying technique is a method of processing a special coating on a surface of a workpiece, wherein a coating material heated to a molten or semi-molten state is sprayed onto a pre-treated surface of a workpiece to form a coating on the surface of the workpiece. For example, to increase the stability and wear-resistance of a bone implant or a dental implant, plasma can be used to melt a material having a high melting point, such as stainless steel, titanium alloy, or cobalt alloy. Then, compressed air is used to spray the molten material onto a surface of an implant to form a coating. Coating materials of different properties may provide different modification and reinforcing effects on the surface properties.

The above conventional thermal spraying technique enables rapid processing and wide applications. Typical plasma spraying can treat materials with high melting points and high cleanliness. A metal material with a high purity has a higher cost. However, during the high-pressure spraying process of plasma, the coating materials in the form of powders may reach a high temperature up to 1300-1700° C. Furthermore, at the high speed of 300 meters/second, only 30% of the coating materials can be stably adhered to the surface of the workpiece while the remaining 70% of the coating materials will splash into the environment, which results in metal dust hazard. Besides, the high-temperature coating materials with irregular shapes may stick to the ambient equipment or fall onto the ambient ground, such that most of the coating materials are difficult to recycle and reuse. Particularly, the materials for medical implants must be free of pollution and have high purity. As a result, the coating materials which scatter and are mixed with impurities cannot be reused.

Thus, it is necessary to improve the conventional thermal spraying technique.

### SUMMARY OF THE INVENTION

To solve the above problem, it is an objective of the present invention to provide a dust collecting device which may improve the material recovery efficiency.

It is another objective of the present invention to provide a dust collecting device which may avoid splash of dust.

It is yet another objective of the present invention to provide a dust collecting device which permits sorting of the powder materials by the sizes of particles.

It is a further objective of the present invention to provide a dust collecting device which may increase the purity of the recycled materials.

As used herein, the term “a”, “an” or “one” for describing the number of the elements and members of the present invention is used for convenience, provides the general meaning of the scope of the present invention, and should be interpreted to include one or at least one. Furthermore, unless explicitly indicated otherwise, the concept of a single component also includes the case of plural components.

A dust collecting device according to the present invention includes a frame, a plurality of impact-resistant plates, a receiving plate, a storage box, and a vibration module. The frame includes a plurality of shielding sides and an open side. The plurality of shielding sides surrounds a working space. The open side is a lateral opening of the working space. The plurality of impact-resistant plates is detachably disposed on at least one of the plurality of shielding sides facing the open side. The plurality of impact-resistant plates is made of heat-resistant and anti-stick material. The receiving plate is disposed on a bottom portion of the frame and includes at least one slope and a pipe. The at least one slope is inclined toward the pipe and includes a bottom end contiguous to an upper opening of the pipe. An angle between a bottom edge of the at least one slope and an edge of the upper opening of the pipe is greater than 90 degrees. The storage box intercommunicates with the pipe. The vibration module is configured for driving the receiving plate to vibrate, such that dusts move from the at least one slope and pass through the pipe into the storage box.

Therefore, in the dust collecting device according to the present invention, thermal spraying process is carried out in the working space defined by the plurality of impact-resistant plates and the frame, which may not only concentrate and collect the spraying material which splash in all directions but also avoid sticking and environmental pollution by the spraying material while enabling recycling and reuse. Furthermore, the plurality of impact-resistant plates may be replaced respectively according to the damage status and the type of the spraying material, which increases the recovery efficiency, reduces the equipment cost, and enhances the work safety.

In an example, the frame further includes a slant located on a top portion of the frame. The slant includes an inner face facing the working space and the open side. The slant includes a through-hole intercommunicating with the working space. Therefore, the through-hole can intercommunicate with a dust collector, and the floating dust generated in the working space can be discharged via the through-hole, thereby providing the effects of sorting of dust and avoiding dust hazard.

In an example, the plurality of impact-resistant plates is disposed on the plurality of shielding sides not facing the open side. Therefore, the plurality of impact-resistant plates may simultaneously shield the spraying material splashing to the ambience, thereby providing the effects of enhancing the dust collection efficiency and avoiding dust hazard.

In an example, the plurality of impact-resistant plates is made of graphite, silicon carbide, silicon oxide, zirconium oxide, or aluminum oxide. Therefore, each of the plurality of impact-resistant plates has characteristics of resistance to high temperature, resistance to impact, high stability, light weight, and low cost. Thus, the high-temperature, high-speed spraying material may be buffered while avoiding sticking or reaction, thereby providing the effects of simplifying collection of the spraying material and saving the equipment cost.

In an example, at least two magnet strips are adhered to a rear side of each of the plurality of impact-resistant plates, and at least two magnetic attraction elements are disposed in a corresponding location of each of the plurality of shielding sides. Therefore, the plurality of impact-resistant plates may be simply fixed to the plurality of shielding sides through magnetic attraction, thereby providing the effects of rapid assembly and rapid detachment.

In an example, each of the plurality of shielding sides includes at least two holes in a location to which a respective one of the plurality of impact-resistant plates is mounted. Each of the plurality of impact-resistant plates includes at least two alignment members associated with the at least two holes. Therefore, each of the plurality of impact-resistant plates may be installed to the exact position by aligning the alignment members with the associated holes, thereby providing the effect of precise positioning and installation.

In an example, the receiving plate includes a plurality of slopes. The plurality of slopes is consecutively connected to each other to form a plate surface of the receiving plate. Bottom ends of the plurality of slopes converge and are contiguous to a peripheral edge of the upper opening of the pipe. Therefore, the receiving plate may form a groove with an inverted conical shape, thereby providing the effects of concentrated material collection and increasing the recovery efficiency.

In an example, the vibration module includes a plurality of vibrating elements respectively located below lower surfaces of the plurality of slopes. Two adjacent vibrating elements are located on two different slopes. Therefore, the plate surface of the receiving plate may vibrate uniformly to avoid the material from accumulating in an area of the plate surface that vibrates relatively weaker, thereby providing the effects of improving movement of the material and enhancing the material recovery efficiency.

In an example, the vibration module vibrates at a frequency of 300-2000 Hz. Therefore, by vibrating each slope, material particles having diameters of 10-120 μm and having a total weight smaller or equal to 20 grams may roll rapidly, thereby providing the effect of enhancing the concentration efficiency of the powder materials.

In an example, the dust collecting device further includes a hole cover detachably mounted to the receiving plate. The hole cover covers the upper opening of the pipe. A gap is formed between an edge of the hole cover and the plate surface of the receiving plate. Therefore, the to-be-recycled materials may pass through the gap and then enter the pipe to restrict the size of the to-be-recycled materials, thereby providing the effect of sorting the materials by the size of particles.

In an example, the hole cover includes a cap and a supporting member. The cap is conic and has a tip facing upward. An end of the supporting member is fixed to a lower surface of the cap. Another end of the supporting member abuts against an inner periphery of the pipe. The supporting member supports the cap in a position above the upper opening. Therefore, the to-be-recycled materials falling onto the upper surface of the cap may slide downward along the conic surface, and the supporting base may stably support the hole cover, thereby providing the effects of enhancing concentration of the powder materials and enhancing the falling efficiency.

In an example, an edge of the hole cover extends downward to form at least two protrusions in contact with the plate surface of the receiving plate. The at least two protrusions separate the edge of the hole cover and the plate surface of the receiving plate to form the gap. Therefore, the at least two protrusions may support the hole cover, thereby providing the effect of avoiding closure of the gap.

In an example, the dust collecting device further includes a pumping unit intercommunicating with a side opening of the pipe. The pumping unit generates air currents in the pipe. The air currents are discharged in a lateral direction. Therefore, a negative pressure state may be created in the pipe to suck the to-be-recycled materials, thereby providing the effect of enhancing the recovery efficiency.

In an example, the velocity of the air currents generated by the pumping unit is 12-20 meters/second. Therefore, the pumping unit may separate particulate materials with a lighter weight and impurities mixed therein, such as dust, thereby providing the effects of sorting the materials by the size of particles and enhancing the cleanliness of the recycled materials.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 is an exploded, perspective view of a dust collecting device of a first embodiment according to the present invention.

FIG. 2 is a perspective view of the dust collecting device of the first embodiment according to the present invention after assembly.

FIG. 3 is another perspective view of the dust collecting device of the first embodiment according to the present invention after assembly.

FIG. 4 is a perspective view of the dust collecting device of a second embodiment according to the present invention.

FIG. 5 is a cross sectional view taken along section line 5-5 of FIG. 4.

FIG. 6 is a partial, enlarged, perspective view of the dust collecting device of the second embodiment according to the present invention.

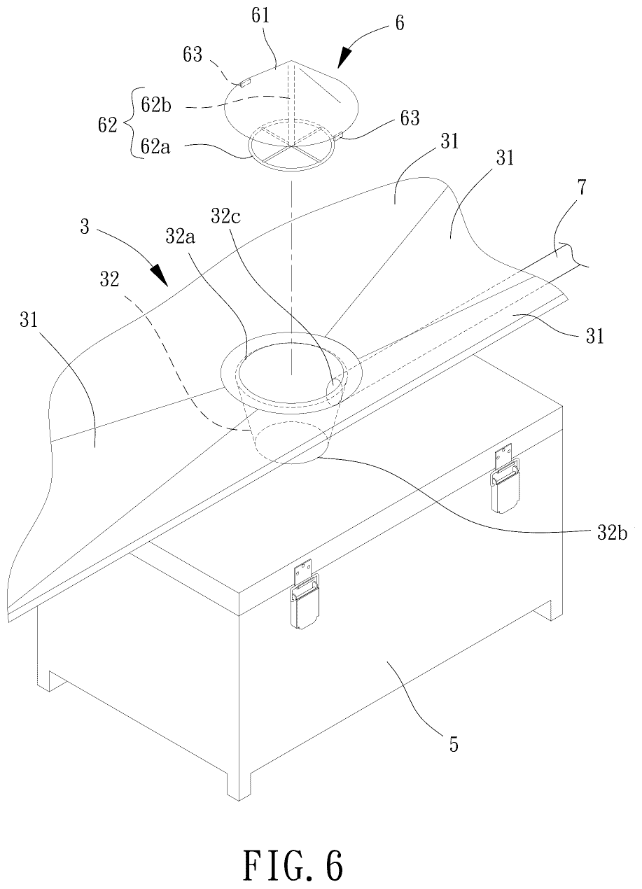

FIG. 7 is an exploded, perspective view of a dust collecting device of a third embodiment according to the present invention.

When the terms “front”, “rear”, “left”, “right”, “up”, “down”, “top”, “bottom”, “inner”, “outer”, “side”, and similar terms are used herein, it should be understood that these terms have reference only to the structure shown in the drawings as it would appear to a person viewing the drawings and are utilized only to facilitate describing the invention, rather than restricting the invention.

### DETAILED DESCRIPTION OF THE INVENTION

In order to make the above and other objectives, features, and advantages of the present invention clearer and easier to understand, preferred embodiments of the present invention will be described hereinafter in connection with the accompanying drawings. Furthermore, the elements designated by the same reference numeral in various figures will be deemed as identical, and the description thereof will be omitted.

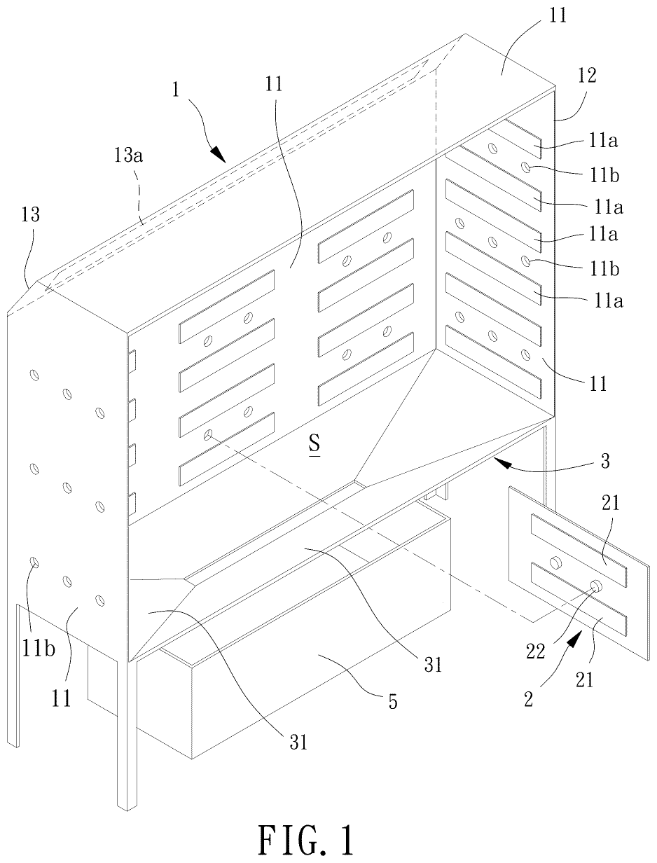

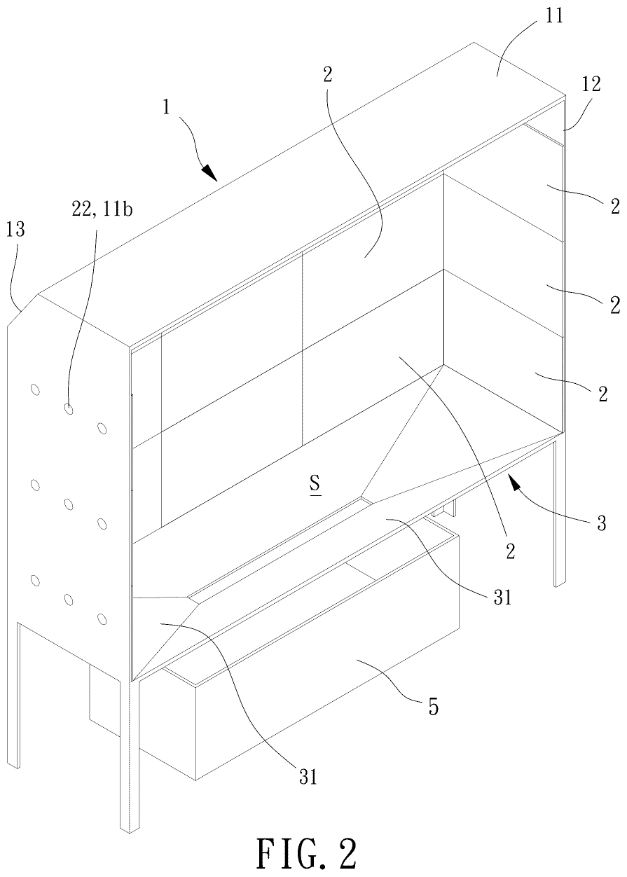

With reference to FIGS. 1 and 2, which show a dust collecting device of a first embodiment according to the present invention includes a frame 1, a plurality of impact-resistant plates 2, a receiving plate 3, and a storage box 5. The plurality of impact-resistant plates 2 is disposed on the frame 1, such as by attachment or adhering. The frame 1 defines a working space S therein. The receiving plate 3 is disposed on a bottom portion of the frame 1. The storage box 5 intercommunicates with a bottommost portion of the receiving plate 3.

The frame 1 includes a plurality of shielding sides 11 and an open side 12. The plurality of shielding sides 11 and the open side 12 are respectively on plural sides of the frame 1. In this embodiment, the frame 1 is in the form of a quadrilateral cylinder having a bottom with four sides. Three shielding sides 11 together form a slanted U-shaped shield and delimits the working space S. The open side 12 is an opening of the working space S. Thus, spraying process may be carried out in the working space S through the open side 12. Nevertheless, the present invention is not limited in the shape of the frame 1 and the quantity of the shielding sides 11 mentioned above. Furthermore, the frame 1 is preferably made of alloy, such as stainless steel. Furthermore, a heat-resistant paint may be coated on the frame 1.

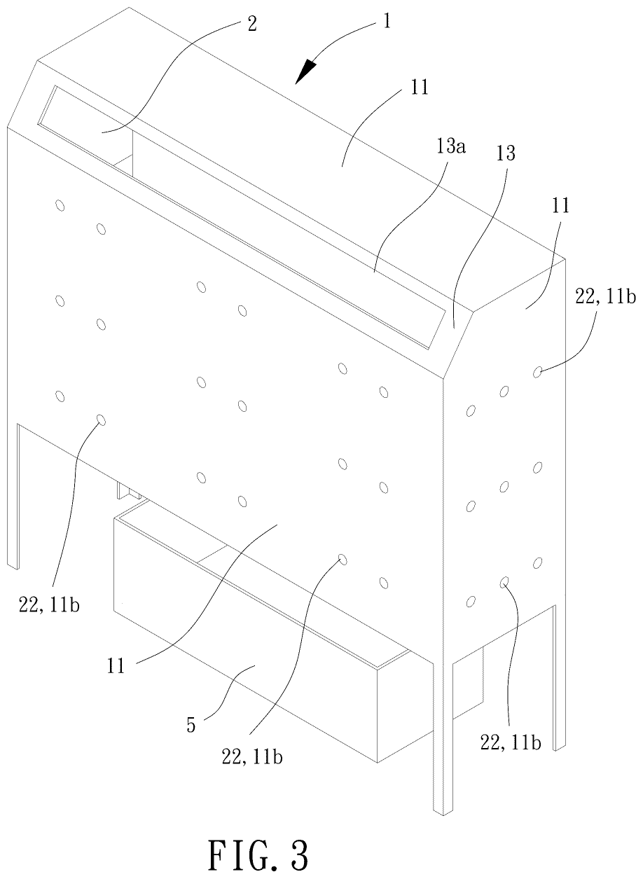

Still referring to FIG. 3, the frame 1 may further include a slant 13 located on a top portion of the frame 1. An inner face of the slant 13 faces the working space S and the open side 12. The slant 13 includes a through-hole 13a intercommunicating with the working space S. Thus, the floating dust generated in the working space S may be discharged via the through-hole 13a. For example, a dust collector may intercommunicate with the working space S via the through-hole 13a. When dust is generated in the working space S during the processing, the dust collector may be activated to drive air for bringing lighter dust away from the working space S, and the lighter dust may be concentrated and collected, thereby providing a safer working environment and recycling the remaining processing materials after processing. In this embodiment, the through-hole 13a is a rectangular hole. Nevertheless, the present invention is not limited in this regard.

With reference to FIGS. 1 and 2, the plurality of impact-resistant plates 2 is detachably disposed on the plurality of shielding sides 11, such as by attachment or adhering. The plurality of impact-resistant plates 2 may be made of heat-resistant and anti-stick material, such as graphite, silicon carbide, silicon oxide, zirconium oxide, or aluminum oxide. When each of the plurality of impact-resistant plates 2 comes in contact with the metal dust that splashes during the thermal spraying, the metal dust may be buffered to reduce the speed, while avoiding the high-temperature metal dust from adhering to the surfaces of the plurality of impact-resistant plates 2. In this embodiment, the plurality of impact-resistant plates 2 is adhered to all of the three shielding sides 11. Nevertheless, when the splashing range of the dust during the thermal spraying is limited, the plurality of impact-resistant plates 2 may be disposed on the shielding side 11 directly facing the open side 12, thereby concentratively stopping the dust directly in the splashing direction. The present invention is not limited to the disposition of the plurality of impact-resistant plates 2 mentioned above. Furthermore, the material of each of the plurality of impact-resistant plates 2 has high stability, such that destruction in the physical structure of each of the plurality of impact-resistant plates 2 or reaction with metal dust may be prevented during the high-temperature thermal spraying process. Therefore, the stopped metal dust will not deteriorate nor will mix with impurities, thereby enabling recycling and reuse.

Different numbers of impact-resistant plates 2 may be disposed on the plurality of shielding sides 11 according to the area and the processing direction. In this embodiment, the three shielding sides 11 are arranged in a slanted U-shaped manner, and the middle shielding side 11 has a maximum area and directly faces the direction of the thermal spraying process and, thus, must withstand impact of more high-temperature metal dust. Therefore, nine (3×3) impact-resistant plates 2 may be disposed on the middle shielding side 11, whereas one by three (1×3) impact-resistant plates 2 may be disposed on each of the remaining two shielding sides 11. Nevertheless, the present invention is not limited to the number and arrangement of the plurality of impact-resistant plates 2 mentioned above.

Furthermore, the plurality of impact-resistant plates 2 may be attached to the plurality of shielding sides 11 by magnetic attraction to enable convenient replacement, installation, and positioning. In this embodiment, at least two magnet strips 21a may be adhered to a rear side of each of the plurality of impact-resistant plates 2, and at least two magnetic attraction elements 11a may be disposed in a corresponding location of each of the plurality of shielding sides 11 and may be used to attract the at least two magnet strips 21a of the respective impact-resistant plate 2. Each magnetic attraction member 11a may be disposed on the inner face or the outer face of a respective shielding side 11. Furthermore, each of the plurality of shielding sides 11 may include at least two holes 11b in a location to which a respective impact-resistant plate 2 is mounted. Furthermore, each of the plurality of impact-resistant plates 2 may include at least two alignment members 22 associated with the at least two holes 11b. Thus, the at least two alignment members 22 are coupled with the at least two holes 11b to position each of the plurality of impact-resistant plates 2, thereby installing the plurality of impact-resistant plates 2 in the correct location. Furthermore, by exerting each of the plurality of impact-resistant plates 2 via the at least two holes 11b, each of the plurality of impact-resistant plates 2 may be easily detached from a respective shielding side 11. Preferably, the at least two holes 11b are located between the two magnetic attraction elements 11a, such that when a force is applied to detach each of the plurality of impact-resistant plates 2, the magnetic attraction may be evenly counteracted, thereby permitting easy removal of each of the plurality of impact-resistant plates 2. Nevertheless, the present invention is not limited to the above-mentioned installation and fixing mechanism for the plurality of impact-resistant plates 2.

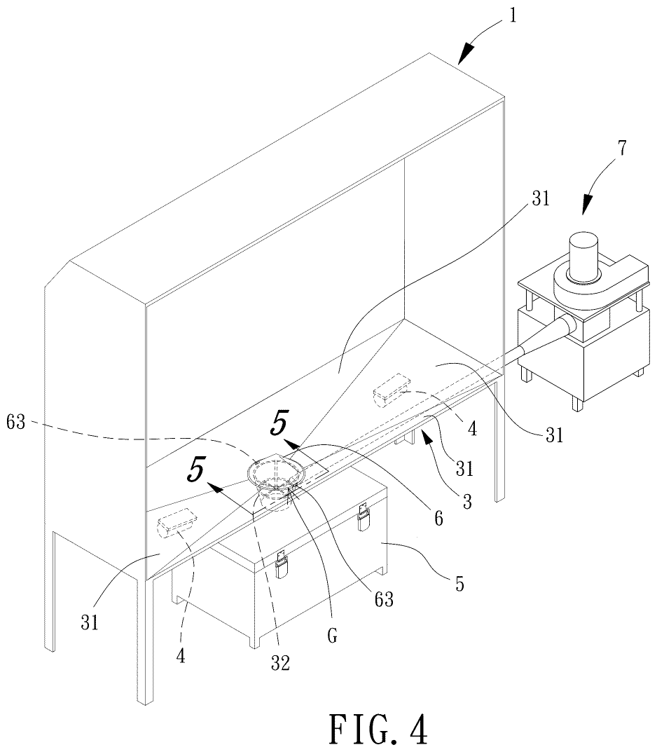

Please refer to FIG. 4 illustrating a dust collecting device of a second embodiment according to the present invention. This embodiment is substantially the same as the above first embodiment. In this embodiment, the receiving plate 3 includes at least one slope 31 and a pipe 32. The at least one slope 31 is inclined from an edge of a section of the receiving plate 3 toward the pipe 32. A bottom end of the at least one slope 31 is contiguous to an upper opening 32a of the pipe 32. Furthermore, an angle between a bottom edge of the at least one slope 31 and an edge of the upper opening 32a of the pipe 32 is greater than 90 degrees. Furthermore, a plate surface of the receiving plate 3 may include a plurality of slopes 31. The plurality of slopes 31 is consecutively connected to each other. Each slope 31 is preferably contiguous to at most two slopes 31. Each slope 31 is inclined from an edge of a section of the receiving plate 3, such that the bottom ends of the slopes 31 converge at the pipe 32 at the bottom portion of the receiving plate 3. An edge of the upper opening 32a of the pipe 32 is contiguous to the bottom ends of the slopes 31. In this embodiment, the receiving plate 3 is quadrilateral and has four slopes 31. The four slopes 31 are respectively inclined from four sides of the quadrilateral toward a center of the plate surface of the receiving plate 3, such that the receiving plate 3 forms a groove in the form of an inverted quadrangular pyramid, and a top portion of the inverted cone is connected to the upper opening 32a of the pipe 32. Nevertheless, the receiving plate 3 according to the present invention may be circular or having any other polygonal shape in cross section. A proper shape of the receiving plate 3 may be selected according to the processing state of dusts, the working range, and the way of collecting dusts. Furthermore, the frame 1 and the plurality of shielding sides 11 may be disposed around the receiving plate 3 in a desired manner. The present invention is not limited to the shape of the receiving plate 3 and the number and arrangement of the slopes 31 mentioned above.

With reference to FIG. 4, the dust collecting device according to the present invention may further include a vibration module 4 configured for driving the receiving plate 3 to vibrate toward the pipe 32. The vibration module 4 may include a plurality of vibrating elements respectively located below lower surfaces of the plurality of slopes 31. The plurality of vibrating elements drives the plurality of slopes 31 to vibrate in the vertical direction, such that the to-be-recycled materials (such as metal particles) on the plate surface of the receiving plate 3 jitter rapidly and slightly and, thus, slide downward along the slopes 31 and fall into the pipe 32. The plurality of vibrating elements is spaced from each other. Two adjacent vibrating elements are preferably located on different slopes 31, such that the plate surface of the receiving plate 3 may vibrate uniformly to avoid reduction in the recovery efficiency of the materials resulting from accumulation of the materials in the area of the plate surface that vibrates relatively weaker. In this embodiment, the receiving plate 3 has four slopes 31, and two of the vibrating elements are located on two of the slopes 31 not contiguous to each other. Nevertheless, the present invention is not limited to the vibration mode, the number of the vibrating elements, and the arrangement of the vibrating elements of the vibration module 4. The vibration module 4 may vibrate at a frequency of 300-2000 Hz, and may be used to enable material particles having diameters of 10-120 μm and having a total weight smaller or equal to 20 grams to roll rapidly.

The storage box 5 intercommunicates with a lower opening 32b of the pipe 32. The to-be-recycled material collected from the receiving plate 3 may pass through the pipe 32 and enter the storage box 5 for storage. Furthermore, the interior of the storage box 5 may be divided into a plurality of grooves or uses replaceable material collecting bags. This enables the materials falling in different processing procedures to be stored separately according to the material characteristics, particle sizes, etc., which avoids mixing or contamination of materials, thereby providing the effects of material sorting and easy recycling and reuse.

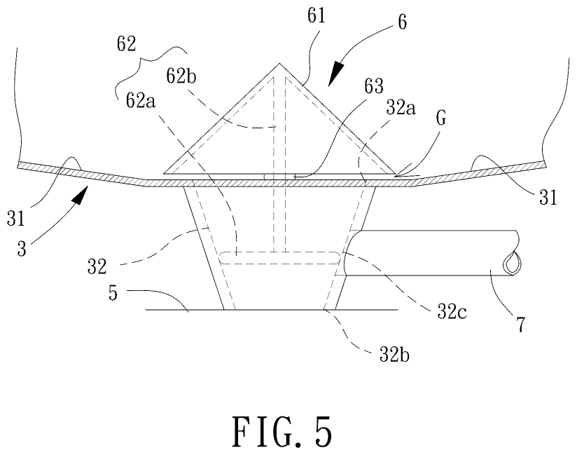

With reference to FIGS. 4 and 5, the dust collecting device according to the present invention may further include a hole cover 6. The hole cover 6 is detachably mounted to the receiving plate 3 and is used to cover the upper opening 32a of the pipe 32 to avoid alien objects other than the to-be-recycled materials from falling into the pipe 32. An area of a projection of the hole cover 6 on the plate surface of the receiving plate 3 is a covering area which is preferably slightly greater than an area of the upper opening 32a. Furthermore, a gap G of 10-15 mm is formed between an edge of the hole cover 6 and the plate surface of the receiving plate 3. The to-be-recycled materials may enter the gap G and then enter the pipe 32, thereby limiting the sizes of the to-be-recycled materials or separating alien objects of a larger volume. In this embodiment, the hole cover 6 includes a cap 61 and a supporting member 62. The cap 61 may be conic and has a tip facing upward. The cap 61 is located above the upper opening 32a, such that the to-be-recycled materials falling onto the upper surface of the cap 61 may slide along the conic side and fall into the gap G. An end of the supporting member 62 is fixed to a lower surface of the cap 61. Another end of the supporting member 62 abuts against an inner periphery of the pipe 32 to thereby fix the hole cover 6. Furthermore, the width of the gap G may be adjusted by adjusting the height of the supporting member 62. Alternatively, an edge of the hole cover 6 may extend downward to form at least two protrusions 63. The at least two protrusions 63 come in contact with the plate surface of the receiving plate 3 to separate the edge of the hole cover 6 from the plate surface of the receiving plate 3 while avoiding closure of the gap G.

The inner periphery of the pipe 32 may be a cylindrical passageway which tapers downwardly. The supporting member 62 may include a supporting base 62a having an annular portion and a cruciform portion connected to an inner periphery of the annular portion. The supporting member 62 may further include a vertical rod 62b. The annular portion of the supporting base 62a is connected to the inner periphery of the pipe 32. Two ends of the vertical rod 62b are respectively fixed to a center of the cruciform portion and an inner side of the tip of the cone of the cap 61. The supporting member 62 may stably support the hole cover 6 and maintain smooth passage of the pipe 32. Nevertheless, the present invention is not limited to the type of the hole cover 6 mentioned above.

With reference to FIGS. 1 and 5, the dust collecting device according to the present invention may further include a pumping unit 7 intercommunicating with a side opening 32c of the pipe 32. When the pumping unit 7 is activated, air currents may be generated in the pipe 32 and discharged in a lateral direction. In addition to creating a negative pressure state in the pipe 32 to enhance the efficiency of the to-be-recycled materials passing through the upper opening 32a, particulate materials with a lighter weight and impurities mixed therein, such as dust, may be separated and flow to the pumping unit 7 along with the air currents, such that recycled materials collected in the storage box 5 are pure particles with uniform sizes, whereas particulates with a lighter weight can be purified and recycled. The velocity of the air currents generated by the pumping unit 7 may be 12-20 meters/second, which can be used to separate particulates of a diameter of 5-10 μm.

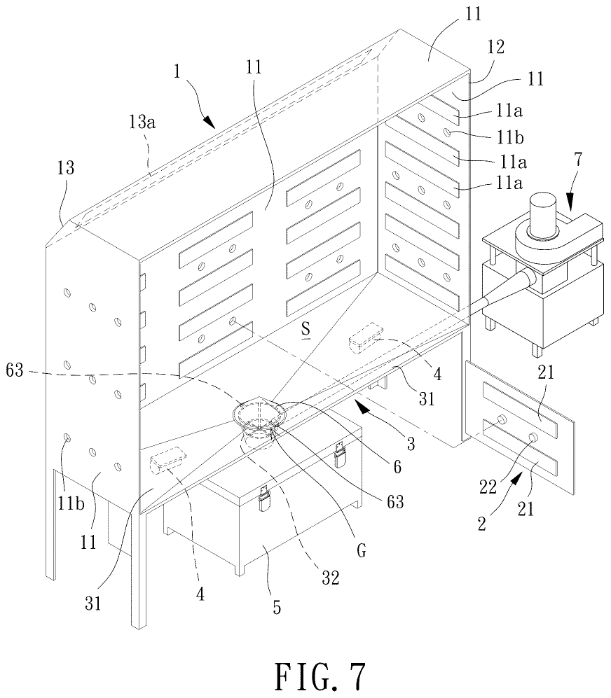

Please refer to FIG. 7 illustrating a dust collecting device of a third embodiment according to the present invention. In this embodiment, the frame 1 and the plurality of impact-resistant plates 2 disclosed in the first embodiment are assembled with the receiving plate 3, the vibration module 4, the hole cover 6, and the pumping unit 7 disclosed in the second embodiment.

In summary, in the dust collecting device according to the present invention, thermal spraying process is carried out in the working space defined by the plurality of impact-resistant plates and the frame, which may not only concentrate and collect the spraying material which splash in all directions but also avoid sticking and environmental pollution by the spraying material while enabling recycling and reuse. Furthermore, the plurality of impact-resistant plates may be replaced respectively according to the damage status and the type of the spraying material, which increases the recovery efficiency, reduces the equipment cost, and enhances the work safety.

Although the present invention has been described with respect to the above preferred embodiments, these embodiments are not intended to restrict the present invention. Various changes and modifications on the above embodiments made by any person skilled in the art without departing from the spirit and scope of the present invention are still within the technical category protected by the present invention. Accordingly, the scope of the present invention shall include the literal meaning set forth in the appended claims and all changes which come within the range of equivalency of the claims. Furthermore, in a case that several of the above embodiments can be combined, the present invention includes the implementation of any combination.

What is claimed is:

1. A dust collecting device comprising:
a frame including a plurality of shielding sides and an open side, wherein the plurality of shielding sides surrounds a working space, and wherein the open side is a lateral opening of the working space;
a plurality of impact-resistant plates detachably disposed on at least one of the plurality of shielding sides facing the open side, wherein the plurality of impact-resistant plates is made of heat-resistant and anti-stick material;
a receiving plate disposed on a bottom portion of the frame and including at least one slope and a pipe, wherein the at least one slope is inclined toward the pipe and includes a bottom end contiguous to an upper opening of the pipe, and wherein an angle between a bottom edge of the at least one slope and an edge of the upper opening of the pipe is greater than 90 degrees;
a storage box intercommunicating with the pipe; and
a vibration module configured for driving the receiving plate to vibrate, such that dusts move from the at least one slope and pass through the pipe into the storage box.

2. The dust collecting device as claimed in claim 1, wherein the frame further includes a slant located on a top portion of the frame, wherein the slant includes an inner face facing the working space and the open side, and wherein the slant includes a through-hole intercommunicating with the working space.

3. The dust collecting device as claimed in claim 1, wherein the plurality of impact-resistant plates is disposed on the plurality of shielding sides not facing the open side.

4. The dust collecting device as claimed in claim 1, wherein the plurality of impact-resistant plates is made of graphite, silicon carbide, silicon oxide, zirconium oxide, or aluminum oxide.

5. The dust collecting device as claimed in claim 1, wherein at least two magnet strips are adhered to a rear side of each of the plurality of impact-resistant plates, and wherein at least two magnetic attraction elements are disposed in a corresponding location of each of the plurality of shielding sides.

6. The dust collecting device as claimed in claim 1, wherein each of the plurality of shielding sides includes at least two holes in a location to which a respective one of the plurality of impact-resistant plates is mounted, and wherein each of the plurality of impact-resistant plates includes at least two alignment members associated with the at least two holes.

7. The dust collecting device as claimed in claim 1, wherein the at least one slope of the receiving plate includes a plurality of slopes, wherein the plurality of slopes is consecutively connected to each other to form a plate surface of the receiving plate, and wherein bottom ends of the plurality of slopes converge and are contiguous to a peripheral edge of the upper opening of the pipe.

8. The dust collecting device as claimed in claim 7, wherein the vibration module includes a plurality of vibrating elements respectively located below lower surfaces of the plurality of slopes, and wherein two adjacent vibrating elements are located on two different slopes.

9. The dust collecting device as claimed in claim 1, wherein the vibration module vibrates at a frequency of 300-2000 Hz.

10. The dust collecting device as claimed in claim 1, further comprising a hole cover detachably mounted to the receiving plate, wherein the hole cover covers the upper opening of the pipe, and wherein a gap is formed between an edge of the hole cover and the plate surface of the receiving plate.

11. The dust collecting device as claimed in claim 10, wherein the hole cover includes a cap and a supporting member, wherein the cap is conic and has a tip facing upward, wherein an end of the supporting member is fixed to a lower surface of the cap, wherein another end of the supporting member abuts against an inner periphery of the pipe, and wherein the supporting member supports the cap in a position above the upper opening.

12. The dust collecting device as claimed in claim 10, wherein an edge of the hole cover extends downward to form at least two protrusions in contact with the plate surface of the receiving plate, and wherein the at least two protrusions separate the edge of the hole cover and the plate surface of the receiving plate to form the gap.

13. The dust collecting device as claimed in claim 1, further comprising a pumping unit intercommunicating with a side opening of the pipe, wherein the pumping unit generates air currents in the pipe, and wherein the air currents are discharged in a lateral direction.

14. The dust collecting device as claimed in claim 13, wherein a velocity of the air currents generated by the pumping unit is 12-20 meters/second.
